(19) United States
(12) Patent Application Publication
(10) Pub. No.: US 2006/0159366 A1
(43) Pub. Date: Jul. 20, 2006

(54) System for rapid delivery of digital content via the internet

(75) Inventor: Sean Darwish, San Antonio, TX (US)

Correspondence Address: DALLAS OFFICE OF FULBRIGHT & JAWORSKI L.L.P., 2200 ROSS AVENUE, SUITE 2800, DALLAS, TX, 75201-2784, US

(73) Assignee: Broadramp CDS, Inc., Las Vegas, NV (US)

(21) Appl. No.: 11/280,850

(22) Filed: Nov. 16, 2005

Related U.S. Application Data
(60) Provisional application No. 60/628,425, filed on Nov. 16, 2004.

(51) Int. Cl. G06F 15/173; G06K 9/36

(52) U.S. Cl. 382/276; 709/223

(57) ABSTRACT

A universal Internet content delivery system is described that is able to deliver any digital content (video, audio, and/or text) over the Internet with excellent fidelity and immediate media launch, devoid of the usual buffering delay as seen with traditional streaming media players such as Windows Media Player or Real RealPlayer. The media is delivered in quick and constant fashion over the Internet with the speed and quality approaching the performance of a local hard drive, regardless of the original media file size. In addition, through the indexing system and navigation side menu, users have the ability to navigate to any section of the media content while the content is streaming over the Internet or any other network, without the delay of buffering a new section each time they navigate to it. The content delivery system sends content stored in format independent media files to a user's browser. The content includes instructions which, using a plug-in in the user's browser, are able to configure the user's browser to play the content.

### CROSS-REFERENCE TO RELATED APPLICATIONS

This application claims priority benefit of U.S. Provisional Patent Application No. 60/628,425 entitled “SYSTEM FOR RAPID DELIVERY OF DIGITAL CONTENT VIA THE INTERNET,” filed Nov. 16, 2004, the disclosure of which is hereby incorporated herein by reference.

### TECHNICAL FIELD

Applicant's invention relates to the delivery of digital content over the internet. More specifically, the present invention relates to a system for electronically transforming, managing, and publishing digital content, such as video, audio, and text, in a single universal format, such that it may be delivered over the internet with speed and quality approaching the performance of a local hard drive, while allowing direct accessibility of any desired segment within the content stream, while the content is streaming over the Internet or any other network.

### BACKGROUND OF THE INVENTION

Traditionally, delivering online multimedia content through the web has been difficult due to the limitations of bandwidth. High-end video media requires substantial bandwidth and post production delivery capabilities that have made this type of media unreachable for most home users. Typical multimedia delivery over the Internet has also resulted in the reduction in size and quality of the video. Video normally seen in full or nearly full-screen sizes when played locally from the user's hard drive becomes limited to small windows one-fifth the size of the original when streamed from a remote server over the Internet. The reduction in size is the only way that current media-player based streaming delivery systems can deliver video without reducing the perceived quality of the media being delivered. If, on the other hand, size of the viewing widow is more important, then the quality of the video is compromised due to pixilation.

Another problem that can be traced to limitations in bandwidth can be seen in the final delivery of the product to the customer. Standard media players must deal with the way traditional media is delivered to the home, usually by a stream of video from the source. The stream speed is dictated by not only bandwidth, but by also packet loss, line interference, etc. Media players will attempt to play a video after a certain percentage of the stream has been buffered. Once buffered, the player will play up until the point where buffering must resume, at which time the player will start again. Frequent start and stops will most likely occur throughout play.

Standard media players function by downloading the video movie and storing the content within the cache of the user's computer. This method facilitates the delivery by allowing the user to view the media again without the need for re-starting the stream. The stream will appear faster and, therefore, be more efficient for the user and the deliverer. The problem with security is present since the user may now save the video stream and distribute it as they see fit. Multimedia companies, who may charge the original viewer a fee for the video, may face serious monetary consequences as the copied video is redistributed throughout the internet.

The constant need to maintain up-to-date software continues to be a problem in all aspects of computer ownership. Operating systems, software programs and utility programs have made upgrading existing software a difficult dilemma. Most standard video streaming technology requires the user to have at least one of two media player software programs and maintain the software with the latest upgrades and patches. Computer users who do not possess these players in order to view the content, or often even if they have the players, they must install plug-ins or other codecs in order to be able to view the specific video stream being delivered. This may require additional configurations that the average novice user is unfamiliar with. Compounding the problem is the pop-up advertising windows that are frequently associated with the player and compromises the efficiency of the viewing experience. Additionally, the media player is now commonly considered the major security intrusion flaw in the PC, allowing spyware, malware, viruses, and Trojans to be introduced into the user's PC.

### BRIEF SUMMARY OF THE INVENTION

The concepts described herein are directed to a system and method in which an Internet content delivery system delivers multimedia content in a single universal common format seamlessly to the end-user's web browser or other software running on an end-user's personal computer adapted to communicate with a server according to the concepts described herein.

The end result of this Internet content delivery system is the best media quality and sound to the user, devoid of the usual buffering delay as seen in other streaming media systems such as Real Player® or Windows® Media Player. Video and audio is delivered over the Internet in quick and constant fashion, regardless of the size of the original media file, without sacrificing the quality or size of the video which often accompanies most other players. In addition, users have the ability to navigate to any section of the media content while the media is streaming over the Internet by the use of the side menu without the delay of buffering a new section each time they navigate. The content delivery system also provides the added security for the originator of the media by limiting the storage of the content on the end-user's computer that is normally accomplished by other media players. Storage and redistribution of the media content is impossible since only traces of the media are ever stored on the end-user's computer. Compromise of copyrighted material is therefore reduced and in most cases eliminated.

In an embodiment, an Internet content delivery system includes media files stored on a standard web server made available for distribution over the Internet. The instructions when executed operable to configure the browser and the plug-in to play the content in the media file in the user's browser.

In another embodiment, a method of delivering content to an end-user is described which includes, analyzing the content in a raw media file to determine preferred settings for the content for delivery across a network, converting the raw media file into a format independent media file, storing the format independent media file on a server connected to the network, receiving a request for the content in the format independent media file from an end-user, and sending the content to the end-user, the content including instructions operable to configure a browser and a plug-in of the end-user to play the content.

In another embodiment, a content delivery system includes a server storing media files, each media file including content and instructions, and a browser on a user's computer, the browser further comprising a plug-in, wherein, upon receiving a request from the user's browser for the content, the server sends the content and the instructions to the user's browser over a network, the instructions operable using the plug-in to configure the user's browser to play the content.

In another embodiment, a method converting raw media content to format independent content in a media file is described, the method including analyzing the frame rate of the raw media content and setting the frame rate to a first frame rate for content with slight motion or still images, to a second frame rate for content with moderate motion, and to a third frame rate for content with high motion. The method further includes analyzing the bit rate of the raw media content and setting the bit rate to a first bit rate for content with slight motion or still images, setting the bit rate to a second bit rate for content with moderate or high video motion.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

For a more complete understanding of the present invention, reference is now made to the following descriptions taken in conjunction with the accompanying drawing, in which:

FIG. 1 is a flow diagram illustrating the process of the invention;

FIGS. 2A, 2B, and 2C are flow diagrams illustrating the player channeling process;

FIGS. 3A, 3B, 3C and 3D refer to the Single Screen Design, the Integrated Menu Controls, the Built-in Screens Inside the Video Area, and the ability to Serve Analog and Digital Video;

FIGS. 4A, 4B, 4C and 4D are screens and diagrams illustrating the automated license creation process;

FIG. 5 is a diagram illustrating the CDS Media Purchasing Options;

FIG. 6A, 6B and 6C are diagrams illustrating the Music Player;

FIG. 7 is a diagram illustrating the secure delivery of music;

FIG. 8 is a diagram illustrating Integrated Donation System;

FIG. 9 is a diagram illustrating the Multilingual and Hearing Impaired Features;

FIG. 10 is a diagram illustrating the download video/music capability;

FIG. 11 is a diagram illustrating the combination set-top box with the CDS;

FIGS. 12 and 13 are diagrams illustrating the SPP video and audio analysis; and

FIG. 14 is a diagram illustrating a CDS search file structure;

FIG. 15 is a diagram illustrating the flow of CDS search events; and

FIG. 16 is a view of an embodiment of an enhanced CDS player interface.

### DETAILED DESCRIPTION OF THE INVENTION

The concepts described herein describe a system and method taking multiple formats of video and audio content, processing the content into a universal format, and delivering it over a network, such as the Internet, to an end-user without the end-user being required to have a media player, such as Microsoft Windows Media Player or Apple Quick Time Media player, installed on their computer. One desirable result of the concepts described herein is to eliminate the need for a media player. Each media player available today utilizes proprietary formats and can require additional codecs to support the multitude of media formats in existence. This multitude of proprietary players and media file types created frustration and confusion with end-users who attempt to watch or listen to video or audio content over the Internet.

Further, the system and method described herein allow users to start video or audio content almost immediately over the Internet, regardless of the size of the original media file, without the need to download or buffer content files, a process that may take many seconds or even minutes to accomplish. Instant user gratification is crucial for content providers delivering commercial messages, as users won't wait to see such messages. Delays in delivery of the content can cost content providers revenue through lost advertising or disgruntled customers. The delay inherent in the current system also results from the proprietary media player used to play content. Those media players required either whole files to play, requiring the user to down load the entire media file, or require buffering, in which a portion of the media file is downloaded and begins playing while the remainder of the file continues to download.

Buffering, however, introduces its own problems into the user experience. Buffering can also be slow to start, depending on the bit rate of the content being downloaded and the connection speed of the user. Perhaps even more annoying, though, is the tendency of buffered content to start and stop repeatedly to allow the media player to re-establish the buffer required to play the content.

To overcome these problems the concepts described herein utilize a content delivery mechanism that can work with any media file format existing in the market today or which may be created in the future. A format independent content delivery system is described that eliminates the need for a user to have a proprietary media player installed on their computer and also eliminates the need for the user to have the latest codecs installed in the media player.

In an embodiment, the content delivery system (“CDS”) takes media content in an existing file format and processes the media file to create a new media file of the content in an universal file format. The new media file is then placed on a server connected to a network, such as the Internet, or an intranet, where it is made available to end-users. Instead of downloading the file onto their computers to access the content, the end-user accesses the content in the media file that is streamed over the Internet, with any segment of that file being made directly accessible, as if it was stored and accessed locally from the user's computer. This streamed content is accessed in a media file through a standard browser, such as Internet Explorer, Netscape, Firefox, Mo-zilla, etc.

Instead of a media player, the content delivery system described herein uses a plug-in, or module in the browser to play the media file in the users browser. The plug-in may be the nearly universal Flash plug-in from Macromedia, or may be an also nearly universal Java plug in which currently reside in almost all users' browsers. Instead of a Flash or Java plug-in any other similar plug-in or module may be used, including custom developed plug-ins or modules without departing from the scope of the content delivery system described herein.

When a user requests content, such as by clicking a link on the user's browser or clicking on an iconic representation of the content file, the server storing the media file for that content begins sending the content to the browser. The first few packets of that media stream contain the instructions to the plug-in to configure the browser to play the media. The process of requesting content, receiving the first packets of the content and configuring the browser should take less than 1 to 2 seconds. Using the content delivery system described herein, therefore, allows the users to begin viewing or listening to the content almost instantaneously, regardless of the size of the original media file.

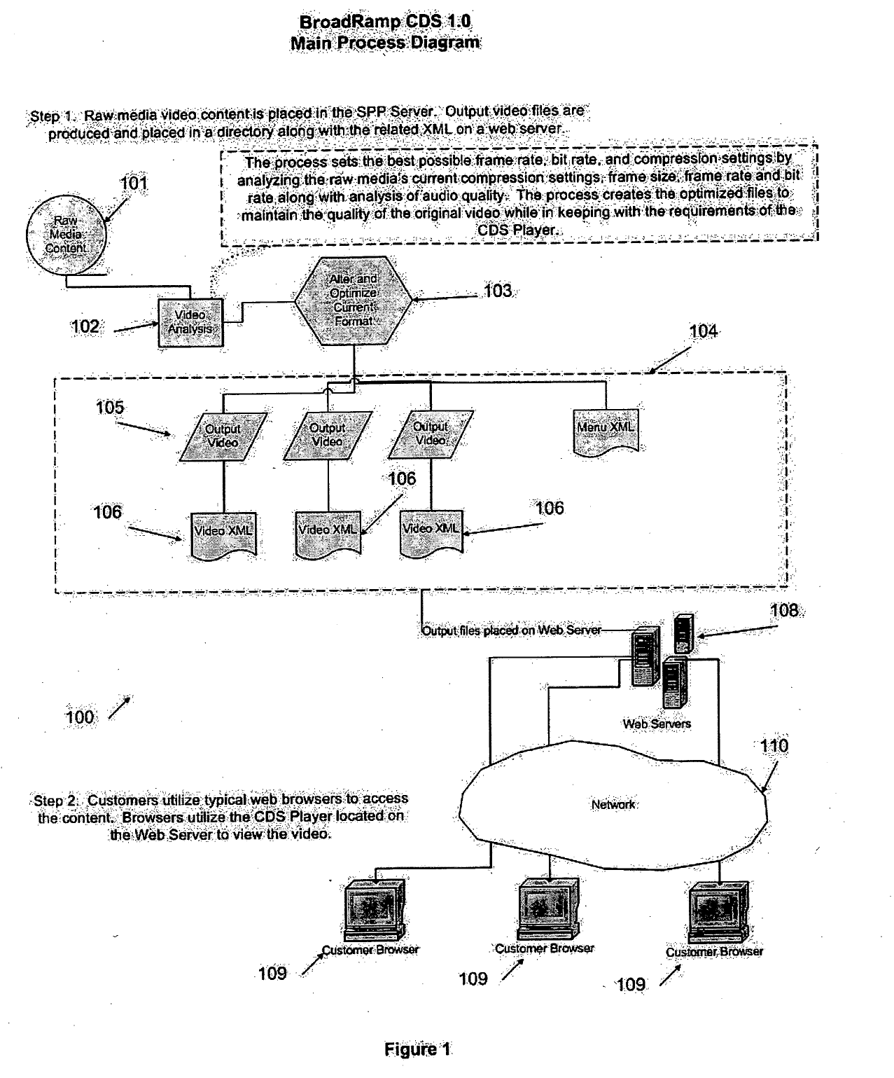

An embodiment of a content delivery system according to the concepts described herein is shown with reference to FIG. 1. Content delivery system 100 begins with raw media content 101. Raw media content 101 can be any type of content stored in any type of media file. Raw media content 101 is sent to content analysis 102 where the content of raw media content 101 is analyzed. For video content, the frame rate, bit rate, and compression settings are analyzed and optimum settings are determined based on the analysis of the content's frame size, frame rate and bit rate along with the audio quality. Content optimizer 103 takes the content and places it into a new file format according to the concepts described herein.

The format utilized by the content delivery system can use a flat data structure such as extensible markup language (“XML”), or any other similar data structure. Once content optimizer 103 has created the data file using the settings determined by content analysis 102, content 104 is created. Content 104 is formed into one or more output content 105, which is associated with an XML content file 106. Output content can correspond to individual elements in the raw media content 101 such as chapters, songs, or other division that may exist or be placed on the original media. Menu XML 107 provides an index into each of the output content files. Content 104 is then placed on servers 108 connected to network 110. Users may then access content 104 over network 110 using browser 109.

The process of taking the raw media files and preparing content 104 can be referred to as the server production process or “SPP” This process may be automated fore the conversion of media files in which the characteristics are well-known, and the output requirements are well defined. In this manner, the CDS™ universal file format may become more broadly deployed through this automate conversion in the general Internet, due to its advantages of lower storage requirements (and costs), lower bandwidth requirements, increased security, embedded player architecture, and greater flexibility and dynamic application integration.

A version of this SPP automated conversion has also been productized that will allow select customers to accomplish this conversion themselves, utilizing their own infrastructure, rather than requiring a provider to provide such services.

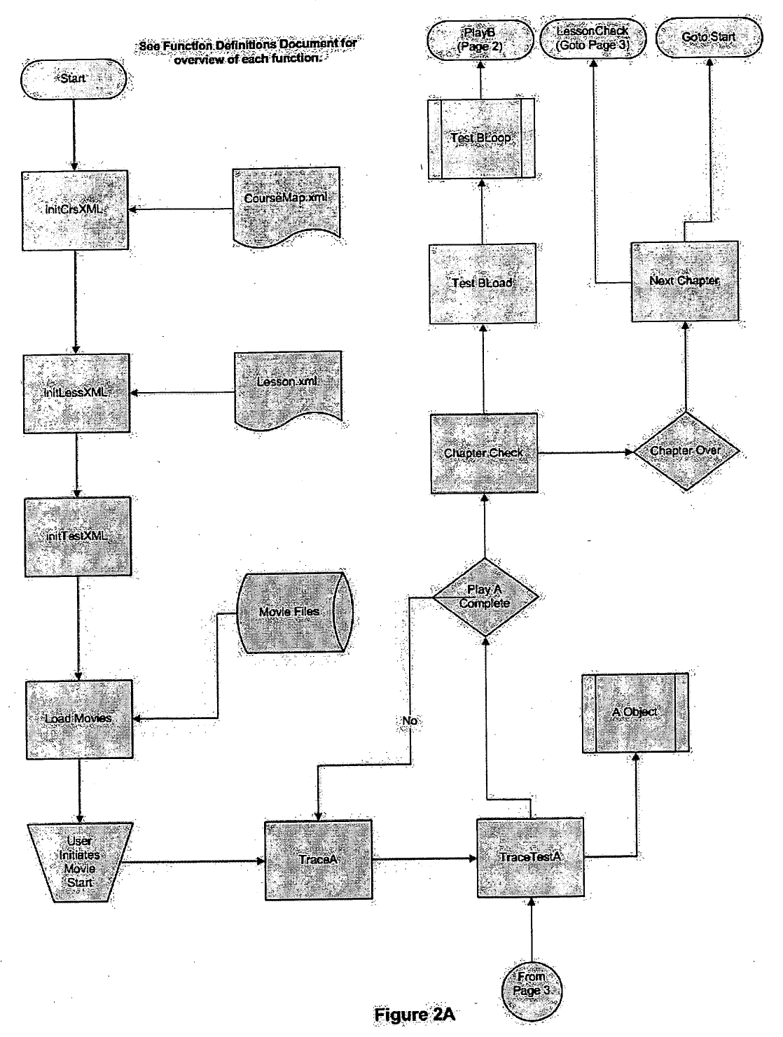

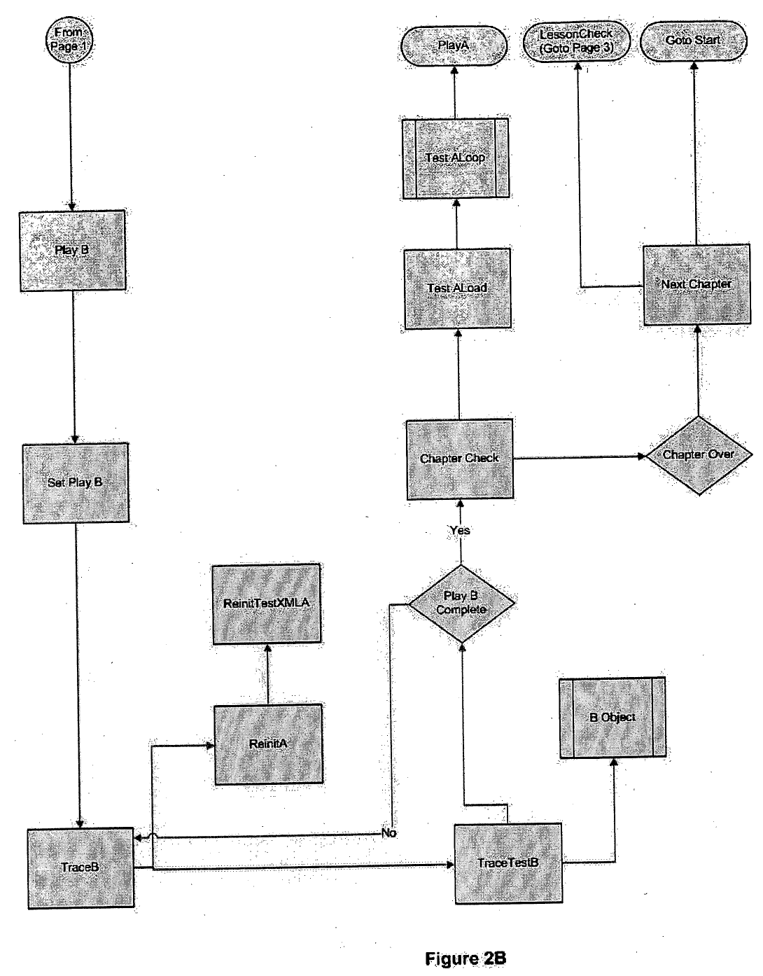

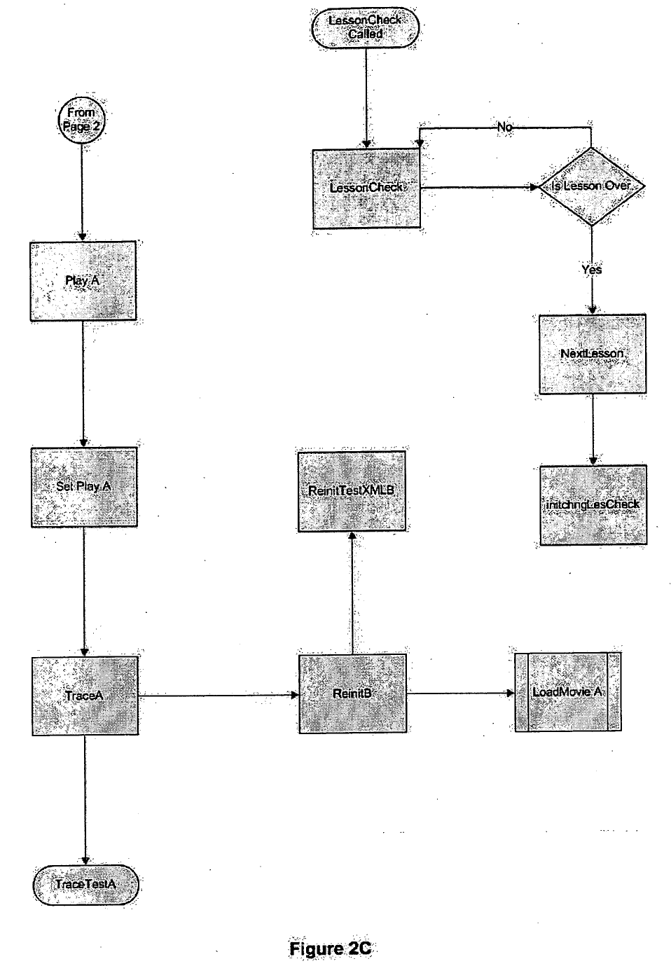

When the user requests content from servers 108, the servers respond to stream the content to the user over network 110. Referring now to FIG. 2, an embodiment of the program used by the servers to deliver the content to the user is described. FIG. 2a begins with function initCrsMXL which initializes the Courses XML Map and parses the variables of coursMap.xml into an array in which each entry has the attributes allocated to the XML. It will then make them accessible by providing an index node, defined by the variable curLesArrayNode, which basically determines what lesson the user is currently taking. Once all this is determined, it initializes the lesson by calling the initLessXML( ) function.

Function initLessXML initializes Lesson Map XML and take the attributes received from the current index node in initCrsXMLQ, specifically the file path to the lesson as dictated by the initCrsXML function. Once it has this path it creates an array to store data and attributes about the individual chapters of that lesson. It also creates an index node for referencing the various chapters (currentChapter). Once all of this is complete, it calls the initTestXML function and starts the chapterCheck cycle.

Function initTestXML initializes the SubChapter Test Array. This function takes chapter file paths from the initLessXML( ) function. Each chapter has a sequence of subchapters that it will stream. This function determines what they are based on an index, n or nn, and builds an Array out of the file paths it finds in each chapter XML. This array holds the file paths to the actual SWF files to be streamed. Once it has the file paths, it will take the first two in the stream and load them into container objects created at runtime.

Function loadMovies loads the data returned from the subchapter test array. Once it begins, the first two objects in the stream queue are being loaded. To actually start the playback of these files the user must press a button in the interface which activates the traceA function. TraceA sets a cycle for traceTestA.

Function traceA is a cycle that runs traceTestA every 0.6 seconds. Function traceTestA traces the load and playback of the individual files loaded into the clip A holder object (holder objects created at runtime). It first determines the length of the file loaded into clip A, and then determines its current frame. Once these two numbers are approximately equal, based on their length minus a few frames for synchronization, it will reset its variables, set the current chapter id as that objects ID, stop its cycle and run a function called chaptercheck, as well as testbload.

Function chapterCheck checks to see if a chapter is complete. If the current chapter index is greater than zero and equals the total chapter nodes then the chapter is over and Function nextChapter goes to the next chapter. If a chapter is over, chapter array index is incremented to retrieve new file paths and IDs and run initCrsXML to restart the cycle. LessonCheckQ is then run to determine if the lesson is over.

Referring now to FIG. 2c, function lessonCheck checks to see if the lesson is over. This is done by determining if the number of lessons equals the current lesson ID and if so the lesson is over. When the lesson is over, the next lesson will be retrieved. Function initchngLesCheck checks if both the chapter and lesson are over, and if so, increments the lesson array index and then runs initCrsXML to start the cycle over on the new chapter. Function nextLesson retrieves the next chapter after the lesson is over by running initchngLesCheck.

Returning to FIG. 2a, function testBload is a combination preloader and playback controller. If 30% of clip B is loaded, based on file size and connectivity, it can be played and will stream properly. If this is true, it will clear the interval checking its current playback, and will run playBQ function. If this is false, it will determine if clip B is supposed to be playing and if the application is actually loading content. If this is true, it will call testBloop which determines if clip B is over 30% loaded, in which case it will play. Function testBloop is a cycle to run testBload every 0.06 seconds.

Referring now to FIG. 2b, function playB plays the clip B object. It sets the player to know that it should be playing clip B. It then determines by the testBload, FIG. 2a, whether clip B is actually loaded and playable. If so, it will play clip B, initialize its playback test, and run the function relnitA. Function setPlayB sets the currently playable movie to clip A object. Function traceB is a cycle that runs traceTestB every 0.6 seconds

Function relnitA reinitializes clip A. It will first retrieve the next subchapter in the subchapter array by making it equal to clip B's index plus one. It then calls the reinitTestXMLA to reinitialize the clip object. Function reinitTestXMLA reinitializes the clip A object. It takes the new index it received from the previous function and determines the file path to its SWF file. It then unloads the current clip in clip A holder and loads the new path into the clipA holder object.

Function traceTestB trace the load and playback of the individual files loaded into the clip B holder object (holder objects created at runtime). It first determines the length of the file loaded into clip B, and then determines its current frame. Once these two numbers are approximately equal, based on their length minus a few frames for synchronization, it will reset its variables, set the current chapter id as that object's ID, stop its cycle and run a function called chaptercheck, as well as testAloadQ.

Function testAload is a combination preloader and playback controller. If 30% of clip A is loaded, based on file sizes and connectivity, it can be played and will stream properly. If this is true, it will clear the interval checking its current playback, and will run playA function. If this is false, it will determine if clip A is supposed to be playing and if the application is actually loading content. If this is true, it will call testAloop which determines if clip A is over 30% loaded, in which case it will play. Function testAloop is a cycle to run testAload every 0.06 seconds

Returning to FIG. 2a, function initLessXML will initialize Lesson Map XML and take the attributes received from the current index node in initCrsXMLQ, specifically the file path to the lesson as dictated by the initCrsXML function. Once it has this path it creates an array to store data and attributes about the individual chapters of that lesson. It also creates an index node for referencing the various chapters (currentChapter). Once all of this is complete, it calls the initTestXML function and starts the chapterCheck cycle.

Referring to FIG. 2c, function reinitTestXMLB reinitializes the clip B object. This function takes the new index it received from the previous function and determines the file path to its SWF file. It then unloads the current clip in clip B holder and loads the new path into the clipB holder object. Referring to FIG. 2b, function nextChap runs the back end complexities of going to the next chapter. Referring to FIG. 2c, function playA plays the clip A object. It sets the player to know that it should be playing clip A. It then determines by the testAload whether clip A is actually loaded, and playable. If so, it will play clip A, initializes its playback test, and runs the function relnitB.

Function setPlayA sets the currently playable movie to clip A object. Function traceA is a cycle that runs traceTestA every 0.6 seconds. Function reinitTestXMLB reinitializes the clip B object. This function takes the new index it received from the previous function and determines the file path to its SWF file. It then unloads the current clip in clip B holder and loads the new path into the clipB holder object. Function reinitB reinitializes clip B. It first retrieves the next subchapter in the subchapter array by making it equal to clip A's index plus one. It then calls reinitTestXMLB to reinitialize the clip object.

As previously stated, the content delivery system described herein uses a plug-in, such as the Flash plug-in, in the user's browser to allow the content delivery system to play the content. The first few packets in the media stream contain instructions to the plug-in on how to configure the browser to receive and play the media from the servers. The use of the browser and plug-in allows the content delivery system to provide digital quality audio and video through the internet that mirrors the performance of a local drive or network.

The content delivery system effectively delivers the media content, which has been transformed by the SPP, seamlessly on the end-user's browser. The results of this process is the best media quality and sound to the user devoid of the usual buffering delay as seen on traditional media players. Video and audio are delivered in quick and constant fashion over the Internet, regardless of the size of the original media file without sacrificing the quality or size of the video which often accompanies most other players. In addition, end-users have the ability to navigate to any section of the media content, while the media content is being streamed over the Internet, by the use of the side menu without the delay of buffering a new section each time they navigate.

The content area, which can be referred to as a player in this context, delivers the media content by receiving the files that were produced by the SPP in the proper order and seamlessly playing them back to the user. The content is made ready for delivery by placing it in the pre-determined directory structure on the server that contains the finalized video and XML files produced by the SPP. Using the browser and plug-in, the content area can be configured to consist of a main viewing area, a pop-up menu window and command buttons. The command buttons allow the user to navigate in and among the contents, and can consist of a ‘forward’ and ‘previous’ button which allows the user to navigate to the next and previous sections of the videos. The command ‘pause’ button allows the user to pause and start the video at anytime. In addition to using the navigation buttons to traverse the video, the user may also use the pop-up menu to select any section.

Once the content area, or player, has been started by the user the initial instructions to configure the browser and plug-in will be downloaded to the computer memory, while at the same time beginning to play the initial media files. The instructions are cached in computer memory in order to prevent future downloads of the player during the current session that the browser is opened. The instructions and content will be cleared from the computer memory once the browser is closed.

The player will read and use a series of channeling methods to properly compile the content to ensure that constant delivery of the media is accomplished. Channeling methods are methods to manage the storage of the video frames within memory in the sequence that they were originally loaded. When the next sequence of frames is needed then the method will grab the next available series of frames. The player will continue loading and channeling the media content until the chapter/section is over or the user initiates a command on the player.

The player incorporates a security feature which prevents the player from starting unless the player is initiated from an authorized website (i.e. www.broadramtpcds.com) through a Hypertext Transfer Protocol (HTTP) web address. Once an attempt to start the player has been initiated, code embedded within the player insures that the Uniform Source Locator (URL) that initiated the command is from an authorized location. This security feature requires that the user be logged into the authorized website thus preventing an unauthorized user from copying the player to another location and attempting to start the player and view the media content.

The CDS™ player is unique in that it is a dynamic data-driven application with interactive controls, integrated into the CDS™ content stream. This CDS™ player and its dynamic database linkage enables such capabilities within the content stream as:
a. E-Commerce
b. Integrated applications
c. Multi-lingual
d. Picture in Picture
e. Movie menu with drop down chapter access
f. Bookmarking
g. Dynamic content updates and changes
h. User authentication
i. License key creation and validation

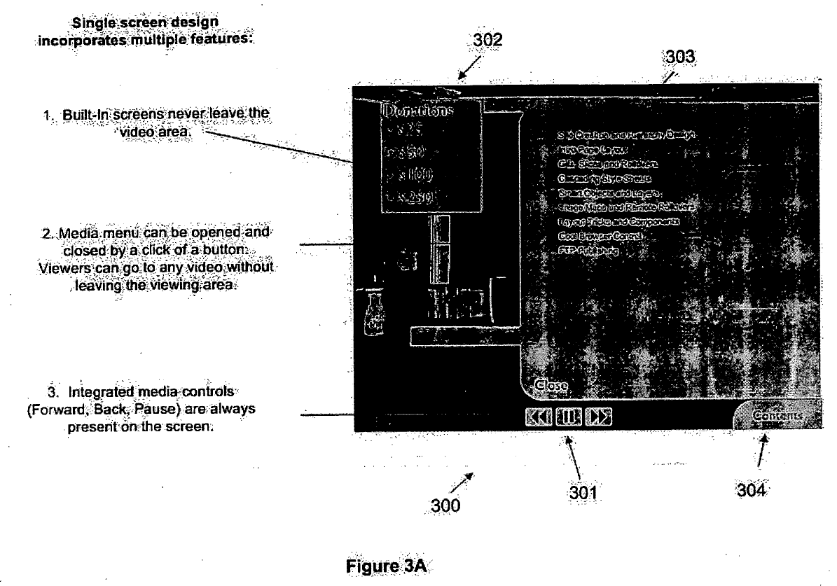

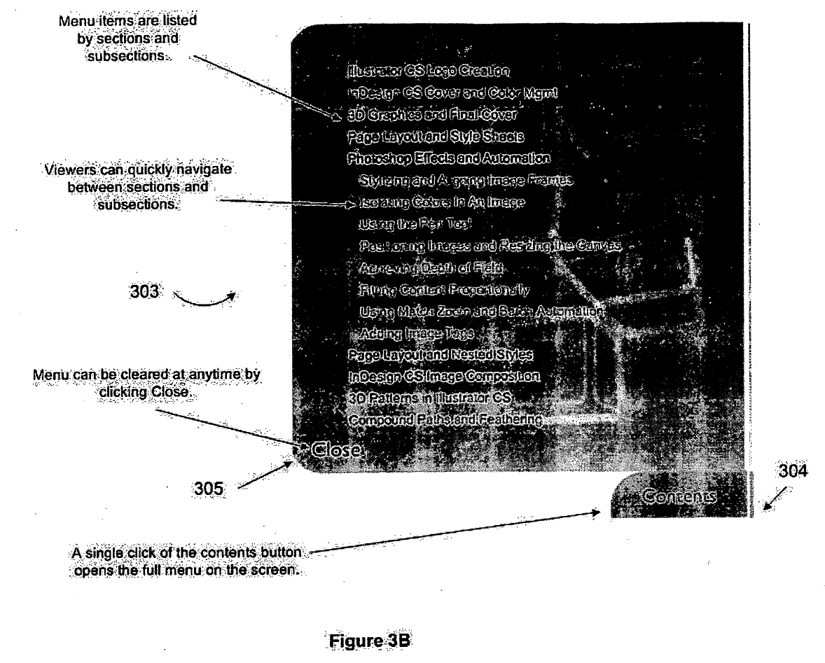

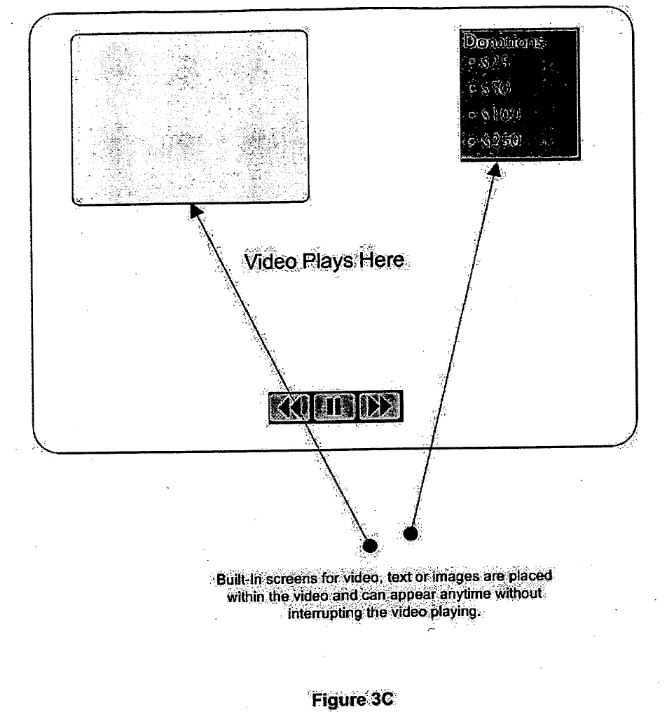

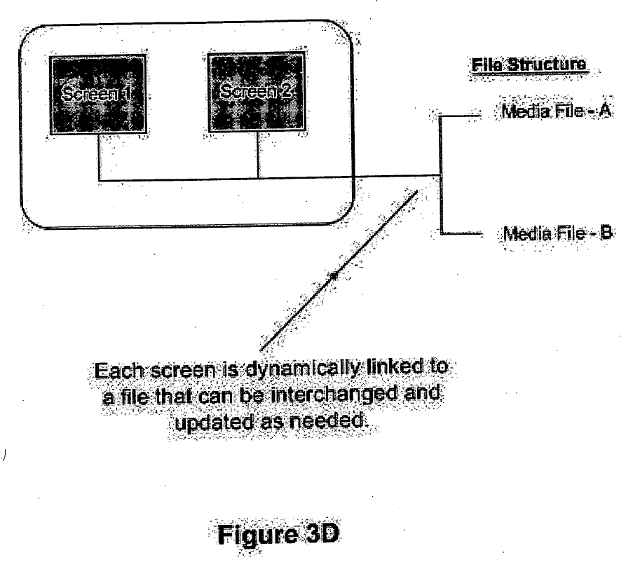

Referring to FIGS. 3A-3D, the CDS player incorporates several features that enhance the viewing experience of the user. One of the features of the player is its single screen design 300 as shown in FIG. 3A. In a single screen design, each component of the player is integrated as a single unit. This single screen design removes the burden of navigation by keeping the user centrally located within the same screen. All controls 301, subscreens 302, menus 303 and other components can be easily accessed from this centralized screen.

The menu 303, shown in greater detail in FIG. 3B, can be designed to provide the viewer with the best navigation experience by maintaining all sections and subsections on a single pane. Each unit of media can be separated by sections and subsections (or in any hierarchy), to allow the viewer to easily find their selections. In addition, the menu can be constantly hidden from view thus saving valuable viewing space. The viewer needs only to click the ‘Contents’ button 304 to bring up the menu and click the ‘Close’ button 305 to hide the menu once done.

The content delivery system allows for additional media screens to be built-in with the video player. This allows for other video content, interactive screens, images or any type of multimedia content to be added to each video. The built-in screens can be set to appear at set intervals and to remain active for a certain amount of time. The screens can be used to accept input from the viewer or other type of direction without interfering with the viewing process. The screens are designed to take content from a set secured file path which allows for quick updates of the content when needed. A detailed view of the built-in screens is shown in FIG. 3c and a view of the file structure of the content is seen in FIG. 3d.

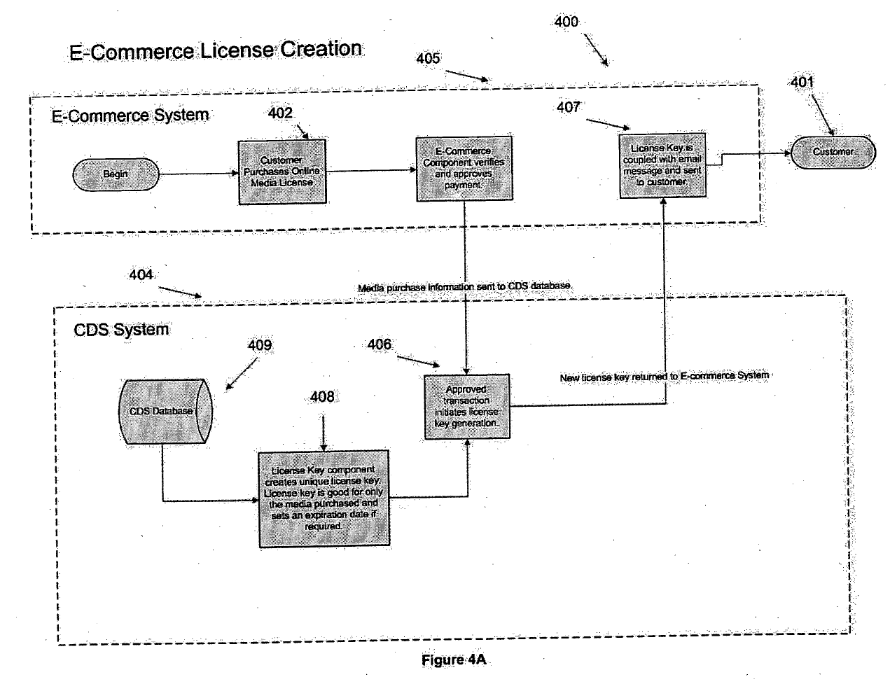

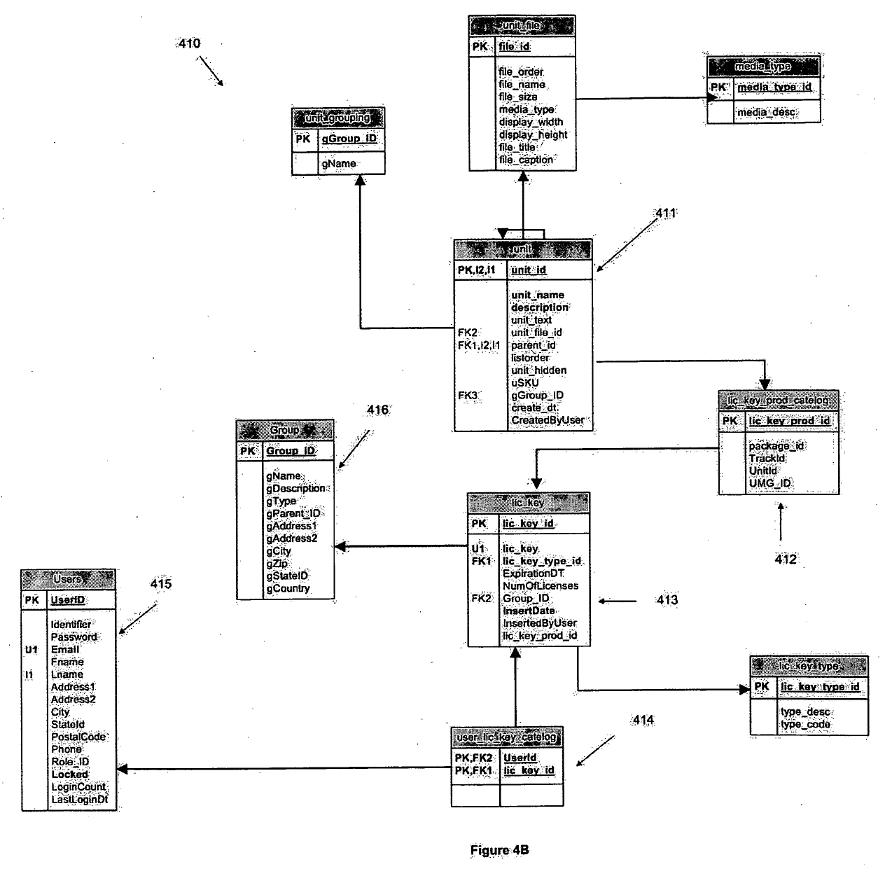

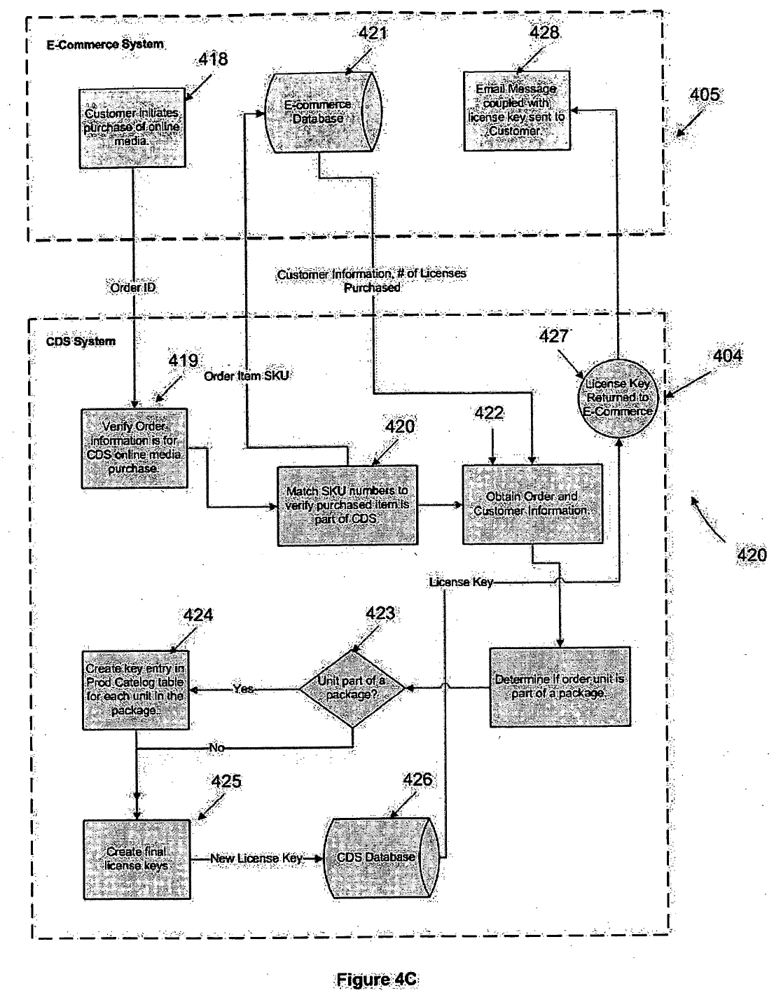

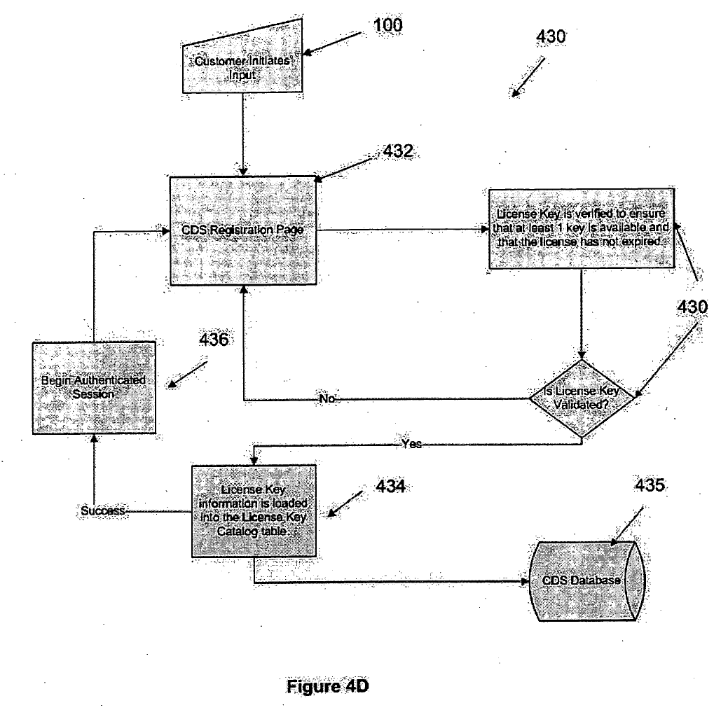

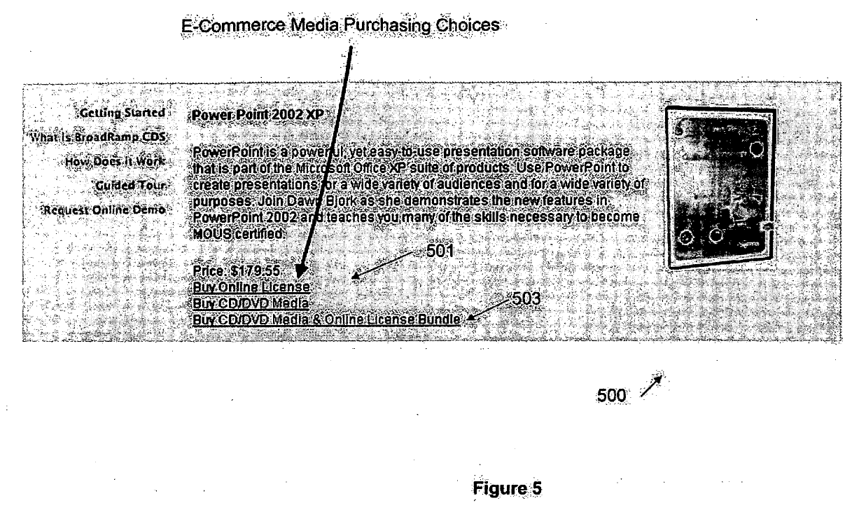

Referring now to FIGS. 4A-4D, an embodiment of an automated license key creation process for use in the content delivery system is described. The automated license key creation process is designed to quickly create and send a license key to the customer for access to protected online media available through the content delivery system. The process prevents the need for human interaction and allows the customer to have immediate access to purchased, or restricted media within seconds. The following description is broken down into three parts: (1) summary of steps in purchasing an online media license; (2) description and design of the license key creation process; and (3) customer registration and authentication procedures.

Referring to FIG. 4A, a block diagram showing a summary of the steps to gain access to restricted online media is shown. First, the customer 401 can browse the media catalog on a website and choose a media to purchase. Next, the customer 401 will follow the steps for access or payment and will initiate a transaction as shown by process 402. In process 403 the e-commerce site 405 verifies and approves the customer's payment, and will send media purchase information to the CDS system 404, as shown in process 406. Upon approval, the customer will receive by email a receipt of the approved transaction shown by process 407. The license key creation initiated in process 406 requires additional action by CDS system 404. The request sent from the e-commerce 405 system to the CDS system 404 to initiate license key creation contains the ID of the media purchased, the number of licenses purchased and the length of time that the license is valid shown by process 408. The license key is generated and stored in the license key table in CDS database 409, and returned to the e-commerce system. The e-commerce system takes the new license key and creates an email message. The email message with the license key is sent to the customer.

The customer receives the license key by email and is directed to a registration page on the CDS system. The customer enters their required information along with the license key and registers. Upon successful registration, the customer has access to their online media and may return to the site at anytime.

The automated license key creation process consists of three main components. The first is the CDS License Data Table Structure which stores the video/media library data and the license key data and the customer information. The second component is the Automated License Key Creation Module which creates the actual license keys used by the customer, and the third is the Customer Registration Component and Authentication Modules which allows the video library to be securely stored and accessed without the threat of being compromised. This section describes in detail each of these components.

An embodiment of the CDS License Data Table Structure 410 is described with reference to FIG. 4B. Unit table 411 is the main media table. Unit table 411 stores information concerning the media (video files) in the CDS system. License Key Production Catalog 412 lists the units that have licenses available. It also shows how the licenses are grouped together in packages (i.e., a video training package contains multiple course sets).

License key table 413 stores all the available license keys along with the keys' expiration dates, and number of licenses available for each key. Lie_Key_Catalog table 414 lists the license keys available for each user. Users Table 415 stores the customer information.

Package Table stores the package/group information of the media. Package Course Table stores the relationship between the packages and the units. Group Table 416 stores the groups (i.e., company, departments, etc.) information. This table is referenced by the license key table to indicate the relationships of licenses to groups.

Referring now to FIG. 4C, an embodiment of the license key creation process is described. The license key creation process 420 is initiated in process 418 by the e-commerce system once the purchase of an online CDS media is completed and the transaction is approved. The e-commerce system will provide the order ID of the transaction to the CDS system in process 419. The CDS system then takes the Order_ID and determines if the order contains purchased online media in process 420. If the order contains purchased online media, then the order information will be extracted from the e-commerce database 421. The order information includes such information as the unit ID, SKU, customer name, email address, and number of licenses purchased. If the order does not contain purchased online media then the process is completed with no action.

The CDS system determines if the purchased unit is part of a package (i.e., box set) in process 423. If true, then a key for each unit of the package is created in the License Key Prod Catalog table 426 in process 424. If false, then just a single entry is created in the License Key Prod Catalog table 426. In process 425, the CDS system will create the required relationships in the License Key Catalog table 426 that are then returned to the user/customer in process 427, which are then emailed to the user/customer by e-commerce system 405 in process 428.

FIG. 4D describes an embodiment of the customer registration module 430. From the CDS registration page 432, the customer enters the required information along with the license key 431. The license key is verified 433 using the License Key Catalog table and the License Key table to verify that the number of licenses used has not exceeded the number of licenses purchased and at least 1 key is available. License Key dates are also checked to insure that the license has not expired. Upon successful license validation, the customer information is loaded 434 into the User table 435. The user/license information is also loaded into the License Key Catalog table. A successful return code from the Customer Registration module 436 directs the CDS Registration page 432 to begin an authenticated session with the user so they are able to access their online media content.

Each customer is able to securely access their content based upon their User ID and Password credentials. Password information is securely stored in the CDS database utilizing a hash encryption algorithm. Database table information is secured utilizing standard SQL encryption techniques with strong password protection.

Customer authentication ensures that a valid license key exists and that at least 1 key has an expiration date later than or equal to the current date. Customers will be provided a 1-week warning prior to any license key reaching its expiration date. Customers are provided an opportunity to renew licenses at any time since licenses will be updated from the original expiration date and not the date that the renewal was initiated.

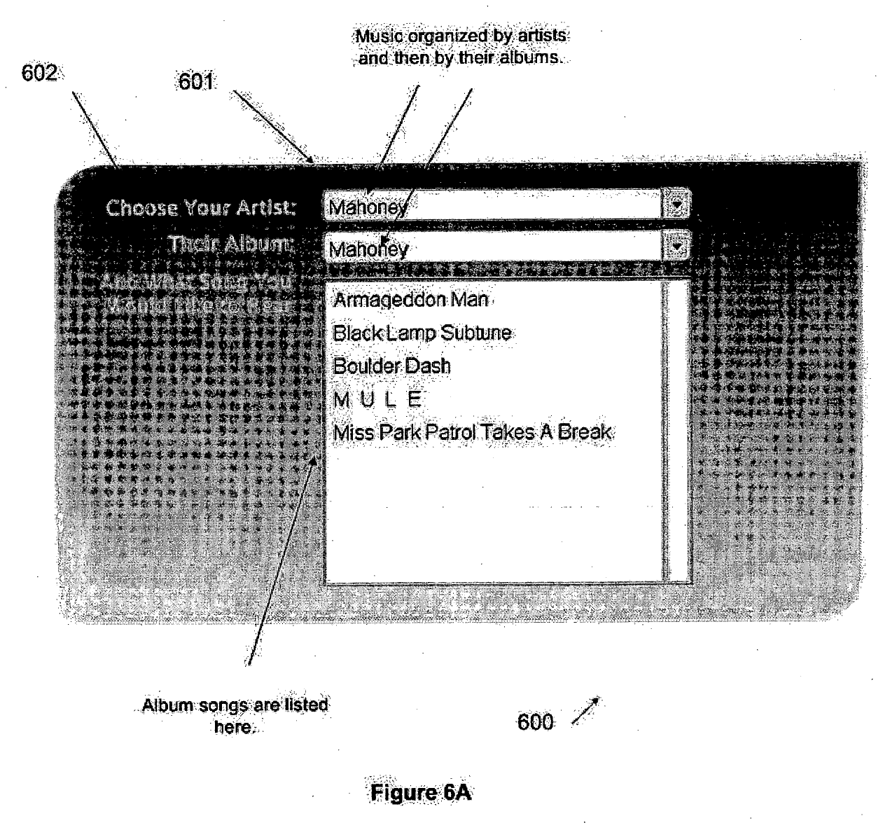

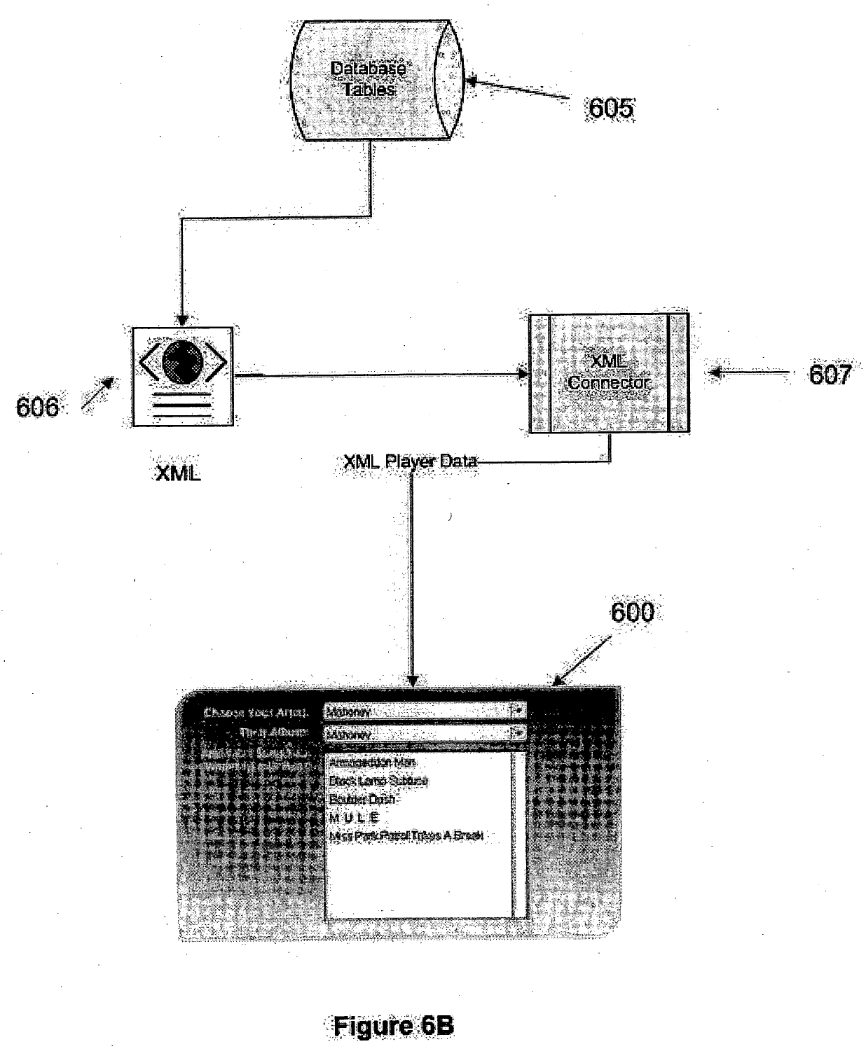

An embodiment of the e-commerce system described herein allows customers to purchase media from three distinct packages. A description of each package is shown below with reference to sample screen 500, shown in FIG. 5. First, a customer may purchase an online media license, shown in link 501, and is immediately emailed the license key. The customer then enters the license key on the site to access their online content. Second, a customer purchases an actual CD/DVD media copy, shown in link 502, which is then shipped directly to their address. Finally, a customer purchases a bundled package, shown in link 503, which includes the online media license as in package #1 and is also shipped a copy of the CD/DVD media as in package #2.

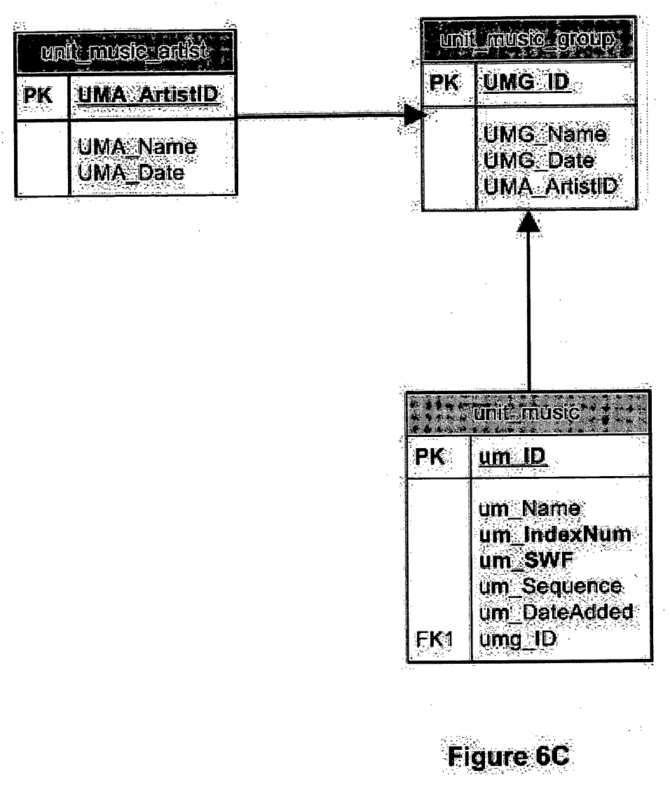

Referring now to FIGS. 6A-C, the content delivery system described herein may also be used to deliver CD quality audio in a format that can be easily managed by even the most novice users. In one embodiment, a music player interface 600 organizes songs by album and artists to enable the user to quickly find and play their music. FIG. 6A illustrates an embodiment of a layout 601 of the music player interface. The detailed design describes how the music data is organized and delivered to the player.

Music player interface 600 utilizes data tables to store the artist 602, album 603, and song information 604. The music player interface obtains its information by first extracting the list of artists that are available to the user logged in and then listing this album/artist information on the music player screen as seen in the data flow diagram, shown in FIG. 6B. The database information 605 is extracted and converted to a XML database 606 that can be easily accessed by the CDS Music Player 600 using XML connector 600. An illustration of a data table structure for use with music player interface 600 as shown in FIG. 6C.

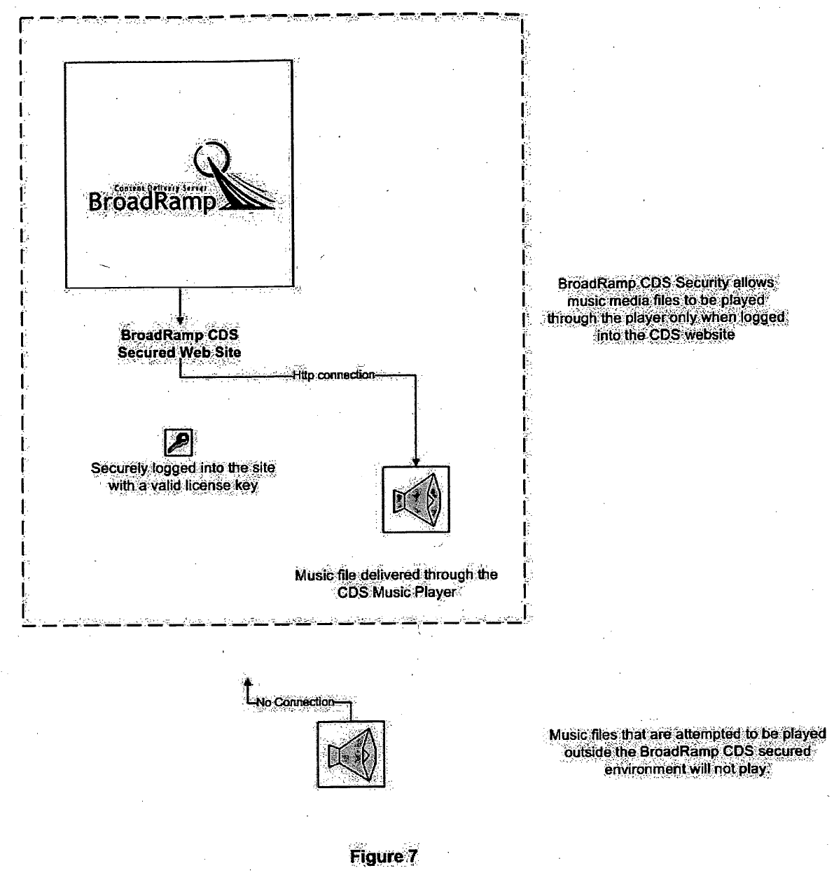

Referring now to FIG. 7, an illustration of security features associated with the media player interface shown in FIG. 6A is described. The security features incorporated into the music player interface prevent a customer from accessing the music outside the secure environment of the content delivery system described herein. A customer must possess a valid media license key and be logged in successfully in order to play the music. Storing and copying music is, therefore, eliminated. The music player interface of the content delivery system provides the music supplier a secured environment to deliver its music.

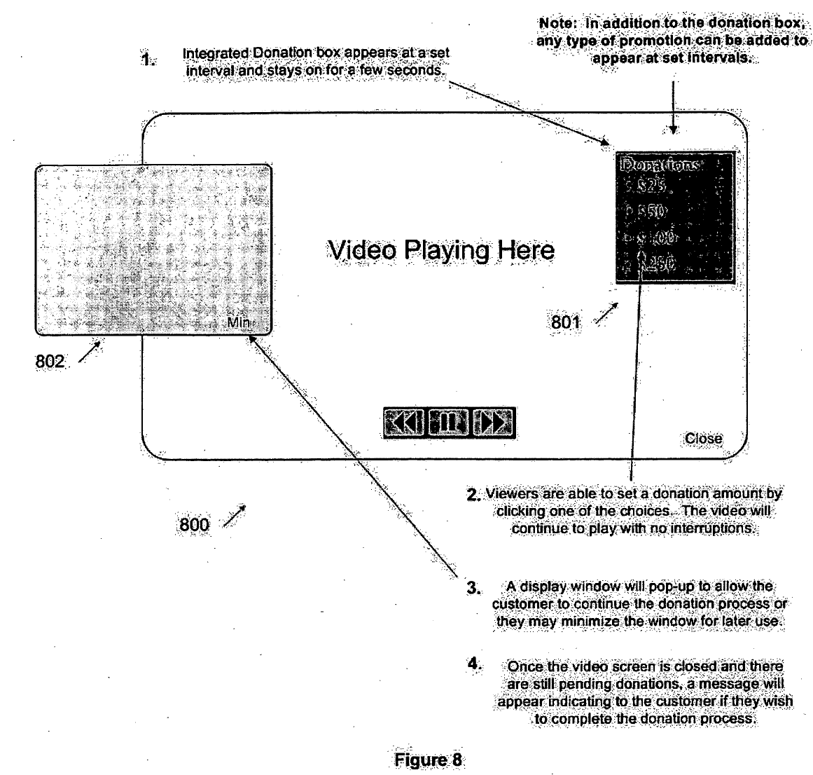

Referring now to FIG. 8, an embodiment of an integrated donation system 800 for the content delivery system described herein, which can be used by churches, other religious organizations and not-for-profit organizations is described. Integrated donation system 800 provides additional functionality customized for churches and not-for-profits of all types. The module provides additional capability to allow organizations to promote their products and accept donations 801 while the video 802 is being played. Viewers can be given the opportunity to select from a range of donation choices and to make an immediate submission without having to leave the area of viewing. This allows for a greater chance that organizations may receive donations.

The integrated donation system is a fully integrated package that combines the video capability of the standard CDS system with the added functionality in support of churches and not-for-profit organizations. One of the main features of the integrated donation system 800 is that it can be accessed by the viewer as he/she is watching the video. An example of a scenario of events is described as follows.

As the viewer is watching the video 802, a donation box 801 will appear at a set interval and stay on for a few seconds. Viewers are able to make a selection by clicking the amount on the donation box while the video is playing. The video will not be interrupted. A pop-up box will appear that will allow the viewer to continue the purchasing process. They may minimize the box and continue the purchase at a later time. Once the video reaches the end of the chapter or it is stopped by the viewer a message will appear to indicate that there is a pending donation. The viewer may then continue the process and complete the transaction. The integrated donation system is also able to incorporate any type of text or promotion item in addition to the donation box 802. Multiple modules can be added and set to display in a certain order and interval.

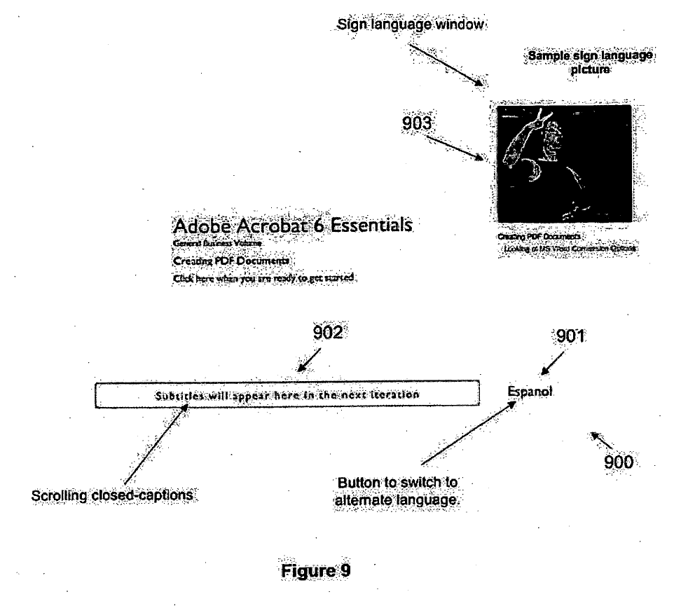

Referring now to FIG. 9, an illustration of the multilingual and hearing impaired features 900 of the content delivery system is described. The multilingual and hearing impaired features are capable of supporting many different media formats including all multilingual and hearing impaired formats. Additionally, users can easily switch to any supported language by a click of a button 901. The player's modular format allows for immediate access to any supported language. The player's multi-screen design supports closed-captioning 902 and sign language capability 903 to assist those with hearing disabilities.

Closed-captioned bar‘902 at the bottom of the screen follows along with the speakers words. A sign language window 903 is provided to follow along with the speaker in the proper sign language format. The multi-language capability is also coupled with the hearing impaired support. If, for example, the user wishes to read the captioning in Spanish, a button 901 can be available which immediately alternates the screen to the supported language. All menus and the closed captions can also be switched to the selected language. The language support will also switch the speaker's voice to the alternate language at the same time. The point at which the alternate language is selected, the voice of the speaker will automatically switch to selected language while keeping the video at the same location. This will allow the user to listen to the speaker in the language of choice.

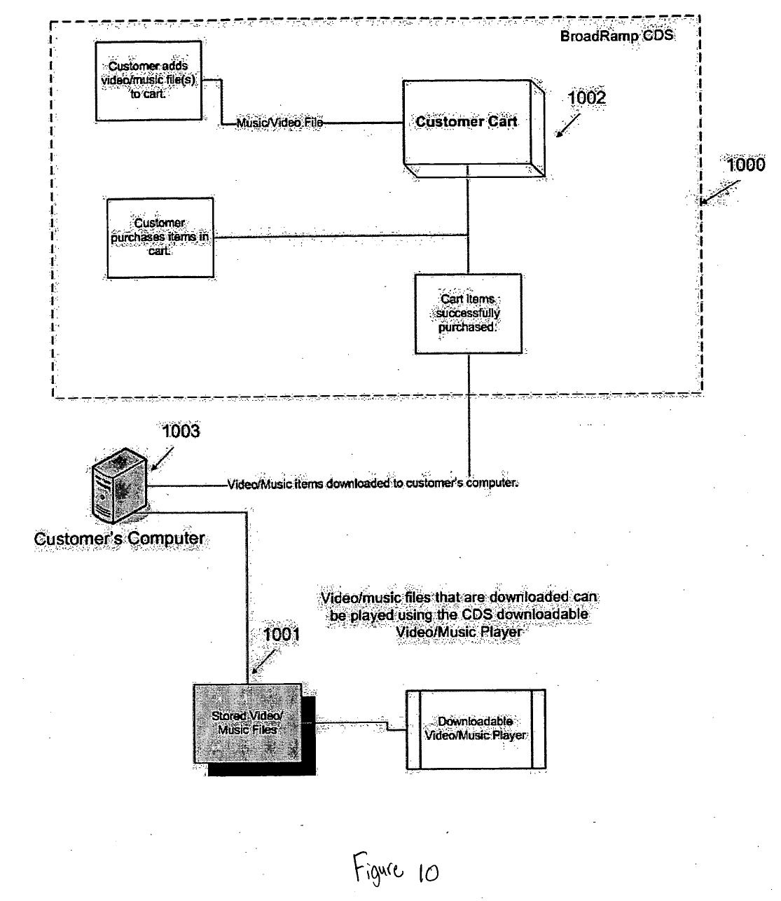

Referring now to FIG. 10, another example of the security features of the content delivery system 1000 is described. The system delivers music securely by preventing the use of the music file unless the file is being played from a website specified by the content provider and the user is properly logged into the system. The music files 1001 will ensure that it is located on the proper HTTP site. If a user attempts to play the music outside the confines of the website, the file cannot be opened or played. This security mechanism makes it impossible to copy and distribute music files since they are useless to anyone outside of the authorized HTTP site.

The CDS system also provides an option for customers to purchase and download video files, music tracks or entire CD collections. Customers who wish to save copies of video/music media are able to purchase the media by clicking an optional ‘Download’ button on the selected video, music track or CD album. Once an item is selected it will be added to the customer's Cart 1002. The Cart keeps track of the selected items along with the total cost. After completing the purchase of the items in the cart, the download procedure commences and the media files are saved in a specified directory. Upon successful delivery of the files to the customer's hard drive 1003, the customer will be provided an option of loading media player interface on their computer and creating a desktop link. The media player interface is used to play the video/music files located on the customer's hard drive.

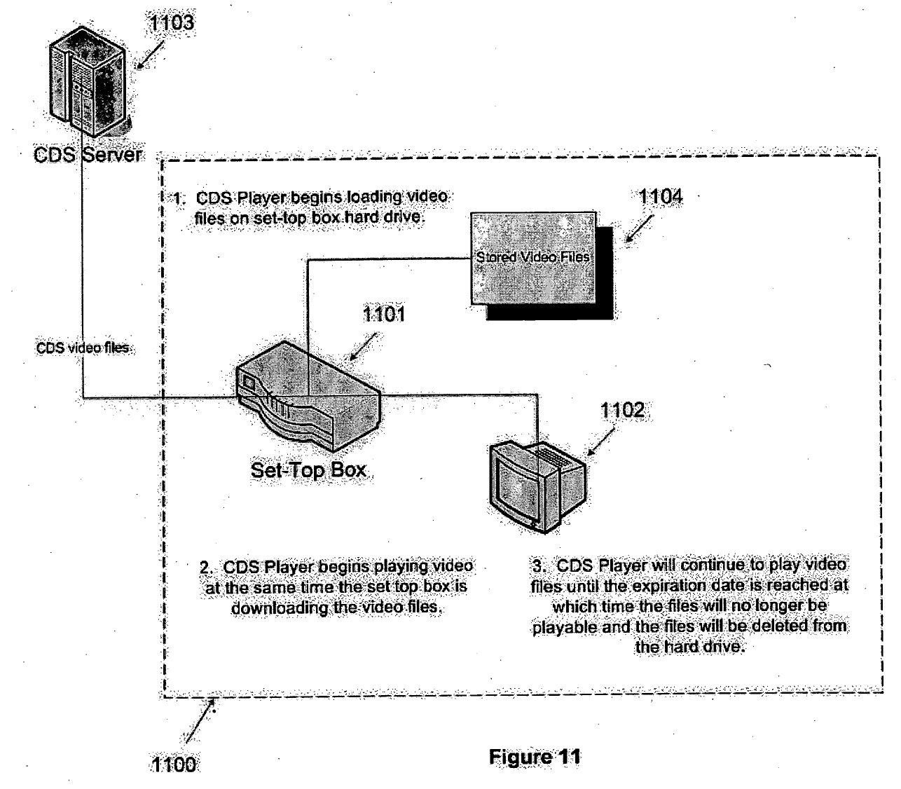

Referring now to FIG. 11, an embodiment of the content delivery system as described herein utilizing a set-top box is described. One or more components of the content delivery system can be installed on a set-top box 1101. IP set-top boxes are devices that are placed on television sets and deliver data, video, and voice services to consumers. System 1100 using a media player interface coupled with a set-top box enhances the video delivery by optimizing the connection between the delivery mechanism and the television 1102. The set-top box 1101 will also enable consumers to download CDS video directly to the set-top box's hard drive that will allow the video to be played multiple times over a set time span.

The content delivery system incorporating a set-top box is able to deliver movies directly to the customer quickly without the need to download the entire video. Customers can browse a video library and then purchase a video for viewing, which is then delivered to the set-top box 1101 from the CDS server 1103. Once the purchase transaction is finalized the customer can begin viewing the movie. While the movie is playing the video files will be stored on the set-top hard drive. The stored files 1104 provide the user the opportunity to view the movie as many times as they wish for a set period of time. Upon reaching the specified expiration date, the movie will no longer be playable and the movie files will automatically be removed.

As stated, the content delivery system described herein delivers a broad range of media by electronically transforming, publishing and managing existing digital content into online interactive multimedia. The basic means of delivering the content is accomplished by utilizing a Server Production Process (“SPP”), and the use of a custom player component.

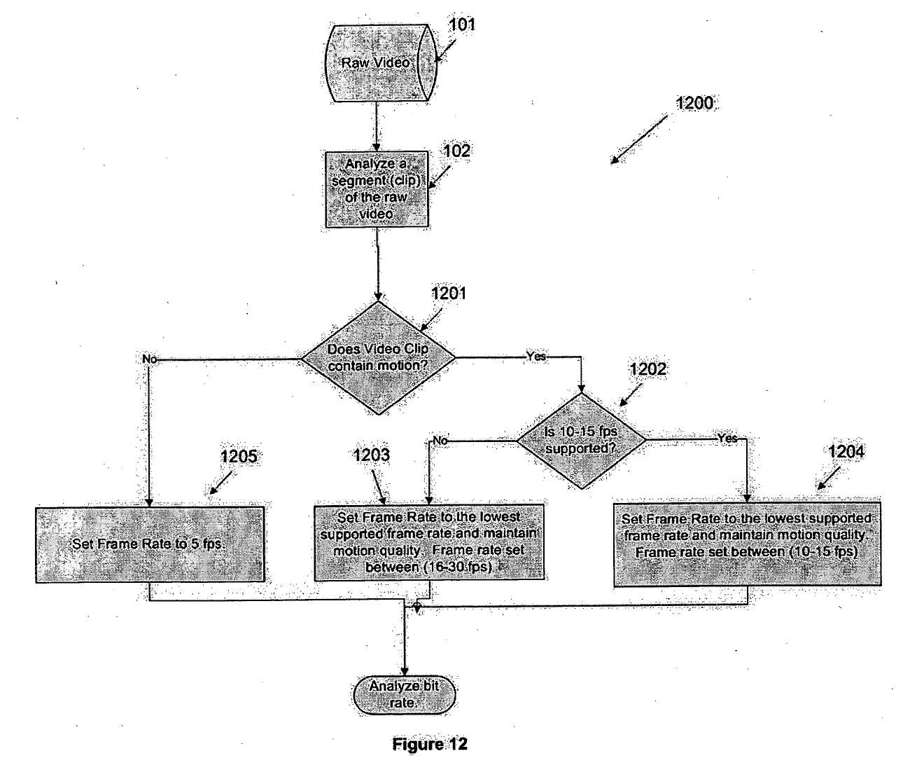

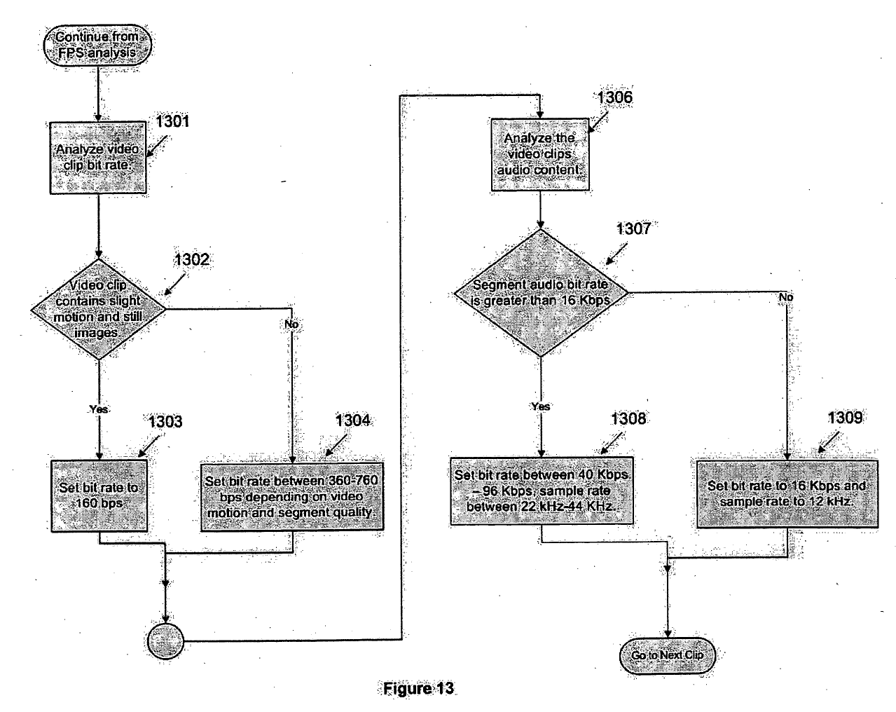

As described with reference to FIG. 1, the SPP transforms and publishes existing video content into a format that can be delivered to the player. The SPP takes video content in a standard format (e.g., MPG, AVI, WMV, etc.), sets the best possible frame rate, bit rate, and compression settings by analyzing the raw video's current compression settings, frame size, frame rate and bit rate along with analysis of audio quality. The process creates the optimized files to maintain the quality of the original video while in keeping with the requirements of the CDS Player. A description of an illustrative embodiment of the SPP video and audio analysis process is described with reference to FIGS. 12 and 13.

Referring to the embodiment shown in FIG. 12, the SPP video and audio analysis process 1200 begins when the raw video 101 is loaded for SPP analysis. Starting from the beginning of the video, each segment is analyzed in process 102. The SPP determines if the video segment contains motion in process 1201. If the segment contains motion, then process 1202 sets frame rate to the lowest supported frame rate to maintain motion quality. Frame rates are set in the range of 16 to 30 frames per second (fps) for high motion, process 1203, or 10-15 fps for standard motion, process 1204. If process 1201 determines that there is no, or very slight, motion the frame rate is set to 5 fps in process 1205.

Next, as shown in the embodiment of FIG. 13 the SPP analyzes the raw video's bit rate shown by process 1301. Process 1302 determines if the segment contains still images or slight video motion then the bit rate is set to 160 kilobits per second (Kbps) in process 1303. If motion and scene changes are greater than can be supported with 160 Kbps then the bit rate is set in the range of 360 to 760 Kbps by process 1304.

In the final analysis the audio quality is set by process 1306. Process 1306 determines if the segment contains audio with bit rates set above 16 Kbps then the bit rate is set in the range of 40 to 96 Kbps by process 1308 with a sample rate set in the range of 22 to 44 kHz. If the segment contains audio with bit rates 16 Kbps or below then the bit rate is set to 16 Kbps with the sample rate set to 11 kHz by process 1309.

The SPP settings in the embodiment described above have been calculated by examining the best possible video quality and delivery through the CDS player that can be obtained with a broadband connection of minimum throughput of 80 Kbps or in some cases less. The SPP video output compression setting produce between 50% and 95% reduction in size from the original video files. While specific frame rates, bit rates and audio qualities have been described, one skilled in the art will understand that different frame rate, bit rates and audio quality standards can be used without departing from the scope of the concepts described herein.

As described with reference to FIG. 1, once the video has been fully structured, a related XA4L file is produced in order to direct the player on the delivery sequence of the videos. In addition, an XML menu file is produced that will assist the end-user in navigating the media. The menu file is produced by the SPP automatically analyzing 1 he breakages within the finalized media. Each breakage will be given a generic ‘Section’ title which can later be altered by our media producer with more detailed titles as determined by the original owners.

After the finalized video files and XML files are produced, the directory is moved to a predetermined location on the server where the player can access the content. The finalized video files incorporate a security feature which prevents the files from being accessed unless the video files are accessed from an authorized website through a Hypertext Transfer Protocol (HTTP) web address. Once an attempt to open the video files has been initiated, code embedded within the video files insures that the Uniform Source Locator (URL) that initiated the command is from an authorized location. This security feature requires that the user be logged into the authorized website thus preventing an unauthorized user from copying the files to another location and attempting to view the media.

The player can deliver video from the original source video that is in either in an analog or digital format.

A productized implementation of this multimedia publishing platform is a multimedia e-book (ME-Book), that incorporates text, audio, and video into a single seamless interactive application accessible to the user while streaming over the Internet. Additional features of the ME-Book include: book-marking, annotations, multi-lingual, narrations, highlighting, zoom, author interviews, special effects (video and audio), e-commerce integration, and application integration. This solution has applicability to all online publishing markets, including but not limited to consumer e-books, online e-magazines, training manuals, assembly and maintenance manuals, e-learning, and website development.

Additionally, the functionality of the player is versatile to allow the delivery of a broad range of multimedia avenues which includes the ability to serve commercials online. The player can be adapted to any size or incorporated into any website to provide a seamless mechanism for the delivery of the technology into any site.

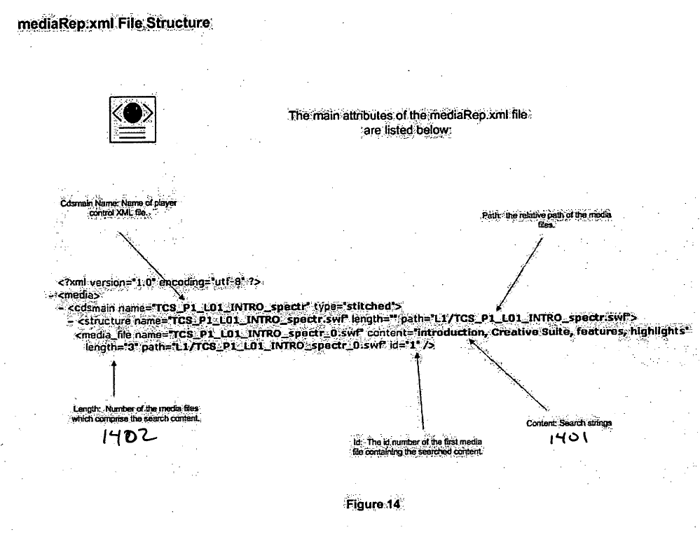

Referring now to FIG. 14, a embodiment of a CDS video search enhancement is described. The enhancement provides the customer with unlimited capability to search any segment of the CDS video and provides them immediate viewing to that portion of the video. The functionality of the system is detailed as follows:

Upon completion of converting the raw video into CDS format, as shown in FIG. 1, an XML file can be created called MediaRep.xml. This MediaRep file is a combination of each XML sequence file produced during the conversion process incorporated into a single file. FIG. 14 shows the structure of the MediaRep file. (As stated earlier, the XML ‘sequence files’ provide the Player with the sequence that the video files are sent to the Player for viewing). The MediaRep file is modified through an editor and provided an attribute called ‘content’ 1401 which contains the key words for the particular segment that is searchable through the CDS module. In addition, the length of the segment is listed in the ‘length’ attribute 1402 which provides the number of media segments following the current segment that the search content covers.

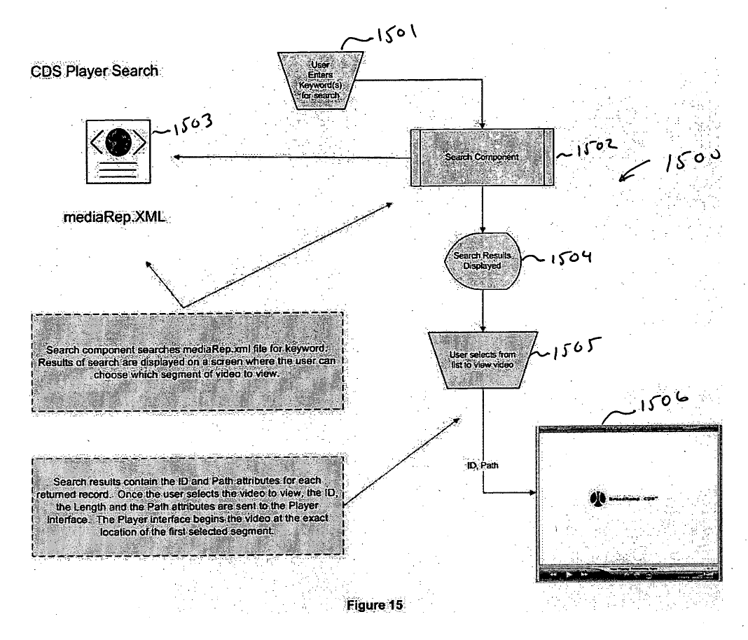

Referring to FIG. 15, an embodiment of the search flow 1500 is described. The user enters a key word(s) to be searched, process 1501, into a textbox. The CDS video search module 1502 searches the MediaRep XML file 1503 for the matched key words and displays the records of the located files in a display 1504. Each displayed record contains the ‘ID’ number, the media ‘Path’ string and the ‘Length’ of the media results which are then delivered to the Player when selected, as shown by selection process 1505. The Player 1506 will start playing the media at the first record of the selected segment and continue playing until the ‘Length’ of media files is reached or until the end of the chapter/section.

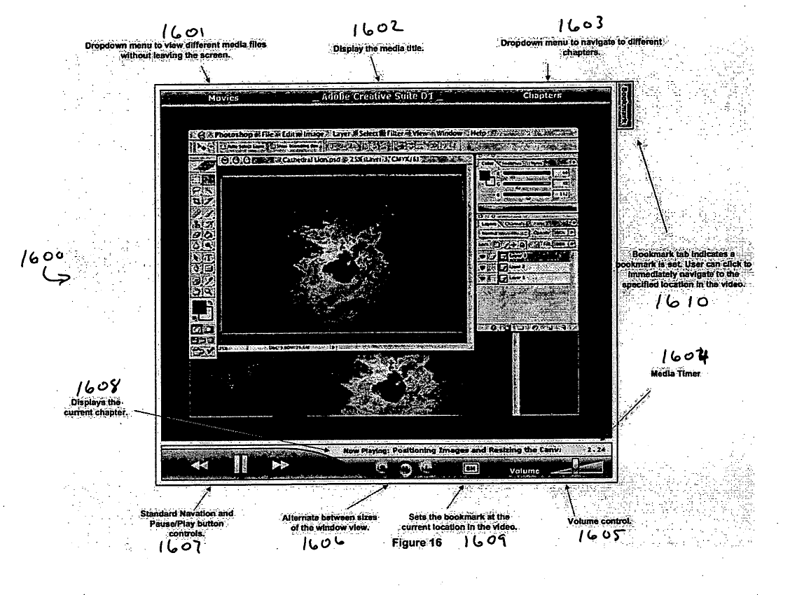

In addition to the standard integrated CDS player interface, an enhanced CDS player interface is available that provides additional controls and features to the user. Referring to FIG. 16, the enhanced CDS player interface 1600 incorporates the following features:
A ‘Movie’ menu dropdown 1601 that allows the user to open alternative video files without having to navigate to a separate browser.
The ‘Video Title’ display 1602 that indicates the name of the current video file.
Dropdown menu 1603 to navigate to the different chapters of the current video.
A ‘Media Timer’ 1604 to show the progress of the current chapter.
Volume control 1605 to adjust the volume of the audio.
Window size control capability 1606 to adjust the Player window between small, medium and large sizes.
Standard Forward and Previous navigation buttons 1607 along with a Pause and Play button.
Chapter window 1608 displays the title of the current chapter.

In addition to the above features, the enhanced Player interface incorporates a ‘book marking’ capability 1609 that stores a single video book mark when selected by the user. The book marking feature operates by storing the current ‘ID’ number and ‘Path’ information that is referenced in the ‘sequence’ XML file. The ID number is stored in memory and is available as long as the browser is open. Once the user clicks the ‘Book Mark’ tab 1610 on the enhanced Player interface, the stored ID and Path are retrieved in memory and the Player begins playing at the exact location. The player will continue to play until the end of chapter is reached.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A content delivery system comprising:
a server connected to a network; and
media files stored on the server, the media files including content and instructions for a plug-in in user's browser, the instructions when executed operable to configure the browser and the plug-in to play the content in the media file of the user's browser.

2. The content delivery system of claim 1 wherein the media files are converted from raw media content having a particular format.

3. The content delivery system of claim 2 wherein the media file is in an extensible markup language (XML) format.

4. The content delivery system of claim 1 wherein the plug-in is a Flash plug-in.

5. The content delivery system of claim 1 wherein the plug-in is a Java module.

6. The content delivery system of claim 1 wherein the plug-in is a custom plug-in.

7. The content delivery system of claim 1 wherein the server operable to authenticate a request for the content by verifying the uniform resource locator (URL) of the request.

8. The content delivery system of claim 1 wherein the browser and plug-in are configured to include command buttons in the content.

9. The content delivery system of claim 1 wherein the content begins playing on a user's browser within 2 seconds of receiving a request.

10. The content delivery system of claim 1 wherein the content is indexed such that the user can navigate between individual portions of the content.

11. The content delivery system of claim 1 wherein the content is selected from the group consisting of: video, audio, and video with associated audio.

12. A method of delivering content to an end-user comprising:
analyzing the content in a raw media file to determine preferred settings for the content for delivery across a network;
converting the raw media file into a format independent media file;
storing the format independent media file on a server connected to the network;
receiving a request for the content in the format independent media file from an end-user; and
sending the content to the end-user, the content including instructions operable to configure a browser and a plug-in of the end-user to play the content.

13. The method of claim 12 further comprising breaking the content in the raw media file into multiple segments and creating an index of the segments.

14. The method of claim 12 further comprising the format independent media file is an extensible markup language (XML) file.

15. The method of claim 12 wherein the plug-in is a Flash plug-in.

16. The method of claim 12 wherein the plug-in is a Java module.

17. The method of claim 12 wherein converting the raw media file into a format independent media file includes analyzing a frame rate, a bit rate and an audio quality for the raw media file.

18. The method of claim 17 further comprising:
setting the frame rate to a first frame rate for content with slight motion or still images, to a second frame rate for content with moderate motion, and to a third frame rate for content with high motion;
setting the bit rate to a first bit rate for content with slight motion or still images, setting the bit rate to a second bit rate for content with moderate or high video motion.

19. The method of claim 12 further comprising receiving a command associated with the content and sending new content to the user in response to the command.

20. The method of claim 19 wherein the command is embedded in the content.

21. A method of delivering content to run in a browser on an user's computer, the browser including a plug-in, the method comprising:
receiving a request from the user's computer at a server connected over a network;
sending the content to the user's computer, the content being stored on the server in a format independent media file, the media file also including instructions for the plug-in and browser, the instructions when delivered with the content configure the plug-in and browser to play the content.

22. The method of claim 21 further wherein the format independent media file is an extensible markup language (XML) file.

23. The method of claim 21 wherein the plug-in is a Flash plug-in.

24. The method of claim 21 wherein the plug-in is a Java module.

25. The method of claim 21 further comprising receiving a command associated with the content and sending new content to the user in response to the command.

26. A content delivery system comprising:
a server storing media files, each media file including content and instructions;
a browser on a user's computer, the browser further comprising a plug-in;
wherein, upon receiving a request from the user's browser for the content, the server sends the content and the instructions to the user's browser over a network, the instructions operable using the plug-in to configure the user's browser to play the content.

27. The content delivery system of claim 26 wherein the media files are converted from raw media content having a particular format.

28. The content delivery system of claim 26 wherein the media file is in an extensible markup language (XML) format.

29. The content delivery system of claim 26 wherein the plug-in is a Flash plug-in.

30. The content delivery system of claim 26 wherein the plug-in is a Java module.

31. The content delivery system of claim 26 wherein the server operable to authenticate a request for the content by verifying the uniform resource locator (URL) of the request.

32. The content delivery system of claim 26 wherein the browser and plug-in are configured to include command buttons in the content.

33. The content delivery system of claim 26 further wherein the server is further operable to receive a command associated with the content and to send new content to the user in response to the command.

34. A method for converting raw media content to format independent content in a media file, the method comprising:
analyzing the frame rate of the raw media content;
setting the frame rate to a first frame rate for content with slight motion or still images, to a second frame rate for content with moderate motion, and to a third frame rate for content with high motion;
analyzing the bit rate of the raw media content; and
setting the bit rate to a first bit rate for content with slight motion or still images, setting the bit rate to a second bit rate for content with moderate or high video motion.

35. The method of claim 34 further comprising:
analyzing the audio content of the raw media content; and
setting the audio content to a audio first bit rate if the audio content has a bit rate less than a preset bit rate and to a second audio bit rate if the audio content has a bit rate greater than the preset bit rate, wherein the second audio bit rate is selected from a range based on the bit rate of the audio content.

36. The method of claim 35 wherein the first audio bit rate is 16 kilo bits per second (kbps).

37. The method of claim 35 wherein the range is from 40 kbps to 96 kbps.

38. The method of claim 34 wherein the first frame rate is 5 frames per second (fps), the second frame rate is between 10 fps and 15 fps, and the third frame rate is between 16 fps and 30 fps.

39. The method of claim 34 wherein the first bit rate is 160 bits per second (bps), the second bit rate is between 360 bps and 760 bps, and the third frame rate is between 16 fps and 30 fps.
